(19) United States
(12) Patent Application Publication
(10) Pub. No.: US 2025/0209934 A1
(43) Pub. Date: Jun. 26, 2025

(54) Piano Scale Master

(71) Applicant: Sergio Armando Barragan, North Bend, WA (US)

(72) Inventor: Sergio Armando Barragan, North Bend, WA (US)

(21) Appl. No.: 18/396,298

(22) Filed: Dec. 26, 2023

(51) Int. Cl. G09B 15/08; G10C 3/12

(52) U.S. Cl. CPC G09B 15/08; G10C 3/12

(57) ABSTRACT

A portable lightweight teaching piano. The piano is equipped with two levels of keys. There is a row of natural keys as well as a row of accidental keys. Each row of keys has a light positioned on the lower quadrant of the key. The keys are connected to a central processing unit and each light is connected to an illuminating unit. The teaching piano has a speaker and a power button. Additionally, the teaching piano has a display screen. The display screen is electronically connected to the central processing unit. When the keys are pushed, a sound is emitted from the speaker, the lights are illuminated and the key letter is displayed on the screen.

### FIELD OF THE INVENTION

The field of the present invention relates generally to devices assistance in teaching music to students. More particularly, the present invention is an apparatus in which the keys light up when pressed.

### BACKGROUND OF THE INVENTION

Teaching piano and music to large groups of students can sometimes be a difficult task. Piano keys are standardly horizontally positioned across a piano and a piano is too large and too heavy to lift us to be able to show a class what key one may be pushing at any given time. Presently, a teacher is left to simply hang a large poster on the wall to indicate particular keys, however, a large poster does not produce a sound for students to learn the notes, chords, and sounds that a key may make when the key is pressed.

It is an objective of the present invention to provide a electronic device which can be hung on the wall in the classroom. Once hung, the apparatus can be turned on which comes equipped with a plurality of modes and preloaded programs one can follow to assist students in learning chords, notes, and keys of the piano. The present invention is lightweight, portable and can be hung with ease. The scale master piano can be plugged into a power source which enables the device to produce a sound once the piano keys are pressed.

### BRIEF DESCRIPTION OF THE DRAWINGS

FIG. 1 is a front view of the present invention.

FIG. 2 is a front-right view of the present invention.

FIG. 3 is a front view of the present invention.

FIG. 4 is a rear view of the present invention.

FIG. 5 is an up close view of the keys and lights of the present invention.

FIG. 6 is a up close view of the speaker and control module of the present invention.

FIG. 7 is an up close view of the power cord of the present invention.

FIG. 8 is diagram showing the invention in use on the wall FIG. 9 is a schematic showing the electrical connection of the present invention.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

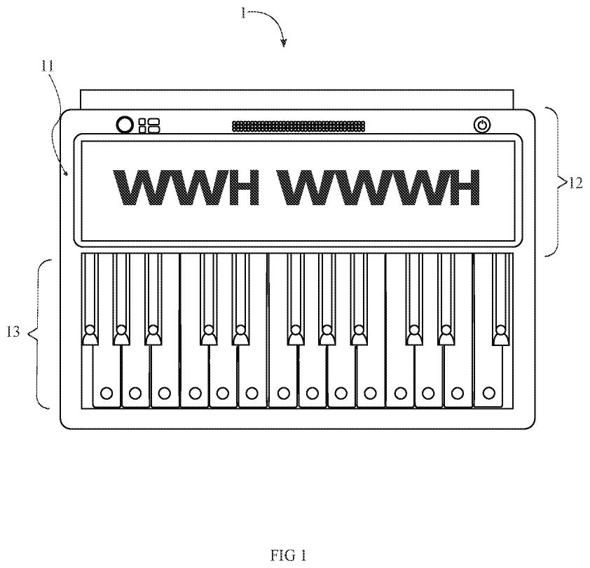

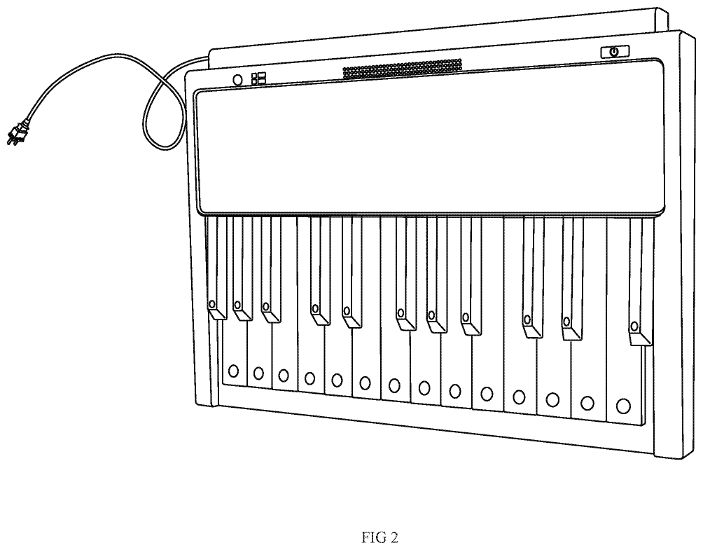

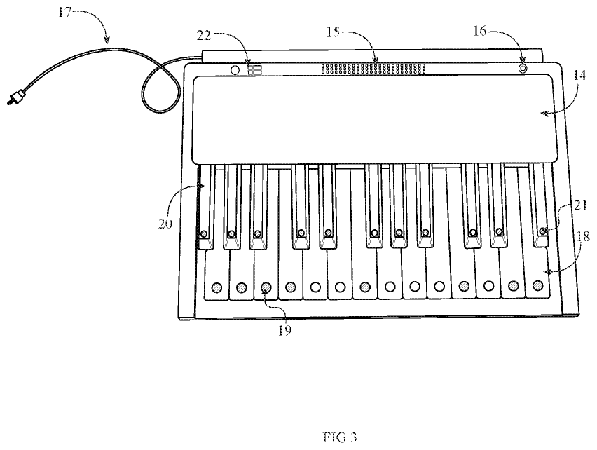

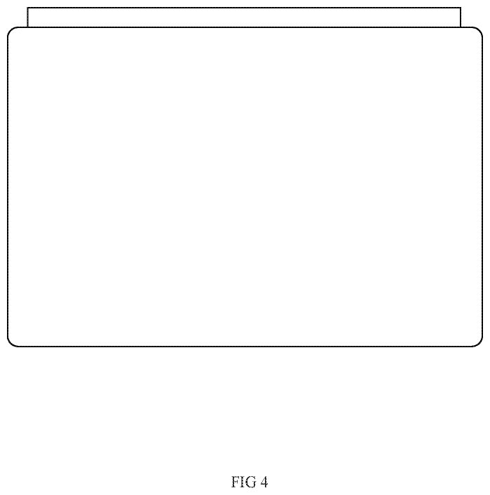

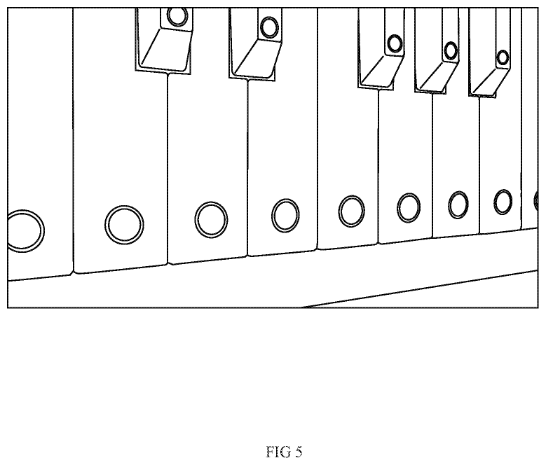

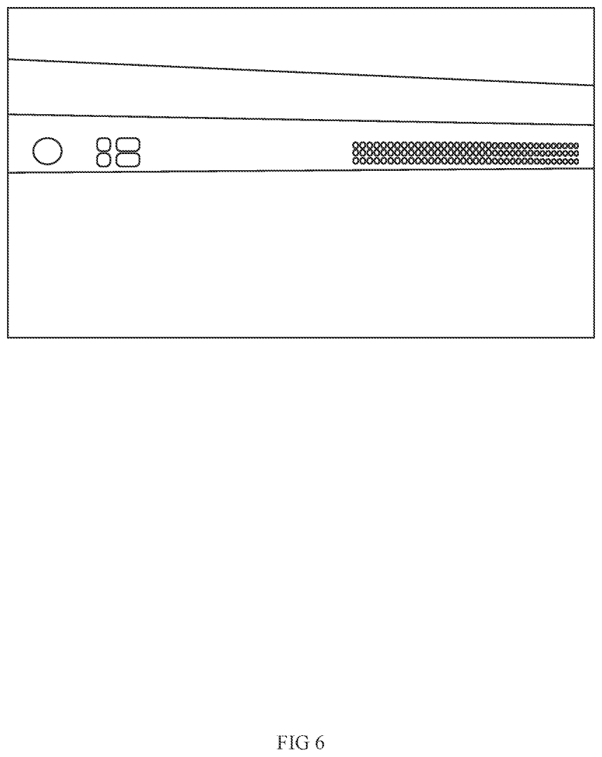

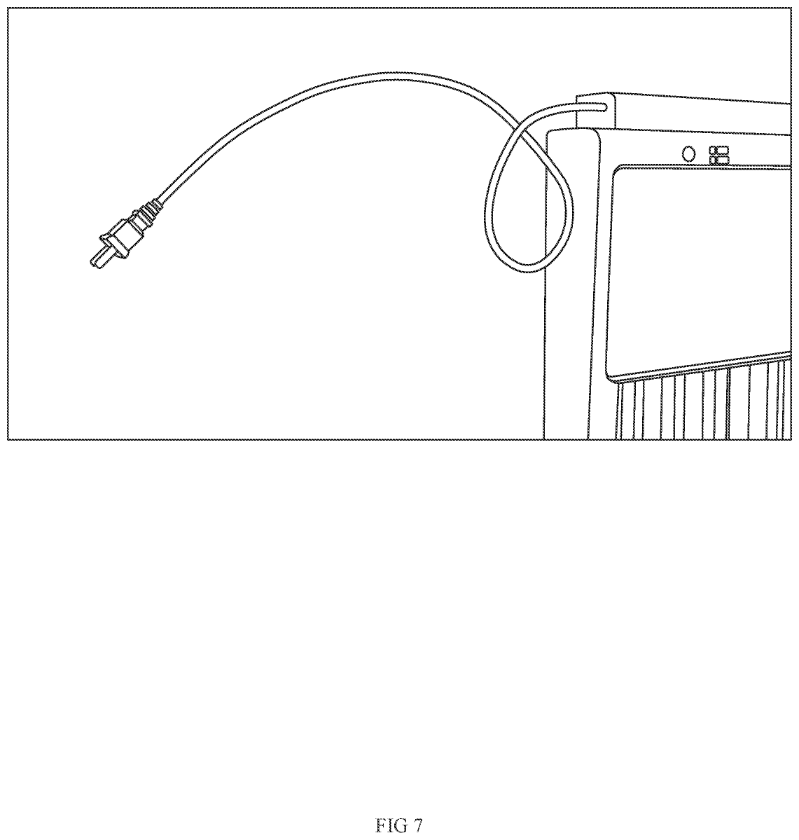

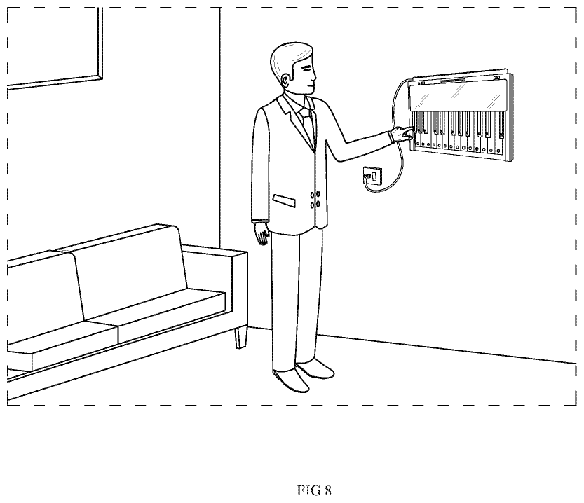

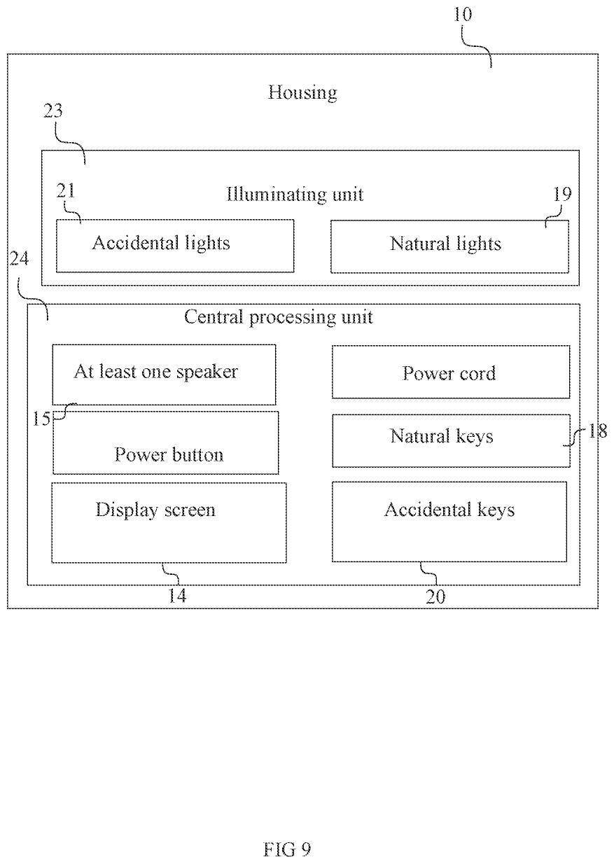

In reference to FIGS. 1-9, the present invention is a portable, hangable teaching piano to aid music teachers in teaching notes, scales, chords, and keys to students. The teaching piano 1 comprises a housing 10, a display 14 screen, at least one speaker 15, a power button 16, and a power cord 17. The housing 10 has a front surface 11 which faces outward from the wall the piano is hung on. The housing 10 also has a control module 22. Contained within the housing 10 of the piano is an illuminating unit 23. Also contained within the housing 10 is the central processing unit 24. The central processing unit 24 is the component responsible for allowing all of the electronic functions of the teaching piano 1 to work. There are two rows of keys as would be found on a standard piano. There are a plurality of natural keys 18 and a plurality of accidental keys 20. The large white keys on a piano are the natural keys 18 and the smaller black keys are the accidental keys 20. Each of the plurality of accidental keys 20 are smaller in nature than that of each of the plurality natural keys 18. The plurality of accidental keys 20 are not as long as the plurality of natural keys 18 and the plurality of accidental keys 20 are fewer in number than that of the plurality of natural keys 18. Each of the plurality of natural keys 18 has a natural light 19 positioned on the lower quadrant of the keys. Each of the plurality of accidental keys 20 has an accidental lights 21 are positioned on the lower quadrant of the accidental key. The natural light 19 and the accidental lights 21 are electronically connected to the illuminating unit 23 such that when a key is pressed on the teaching piano 1, the natural light 19 and accidental light 21 of the respective key that is pressed is illuminated.

Allowing the illuminating unit 23 and the central processing unit 24 to operate properly, is a power cord 17. This power cord 17 is plugged into any wall outlet, which then supplies the necessary power needed to operate the teaching piano 1. The power cord 17 traverses through a wall of the housing 10 and is electrically connected to the central processing unit 24.

The front surface 11 of the teaching piano 1 has an upper half 12 and a lower half 13. Mounted on the upper half 12 of the front surface 11 is the display 14 screen. This display 14 screen will light up with the letter of the corresponding piano key when pressed. For example, if you were to push the “C” key, when the key is pressed a C will be shown on the display 14 screen. Each of the plurality of accidental keys 20 and the plurality of natural keys 18 are mounted on the lower half 13 of the front surface 11 of the housing 10. Positioned above the display 14 screen is the at least one speaker 15. The at least one speaker 15 is electronically connected to the central processing unit 24 such that when a key is pressed the sound the key is emitted through the at least one speaker 15. A control module 22 is mounted on the front surface 11 of the housing 10. The control module 22 is a series of buttons that can control the mode that teaching piano 1 is in. The teaching piano 1 has programs that are preinstalled to teach the students music as well as a free operation mode, which allows the users to press keys of their choosing. The control module 22 is positioned on the right side of the at least one speaker 15. The power button 16 is positioned on the right side of the at least one speaker 15. The power button 16 is responsible for turning the teaching piano 1 on and off. The control module 22 is electronically connected to the central processing unit 24 which enables the teaching piano 1 to operate in various modes. The power button 16 is electronically connected to the central processing unit 24.

The display 14 screen is electronically connected to the central processing unit 24. This allows the display 14 screen to display 14 the corresponding letter of the key that is pressed. Also connected to the central processing unit 24 is the plurality of accidental keys 20 and the plurality of natural keys 18. The plurality of accidental keys 20 and plurality of natural keys 18 are connected to the central processing unit 24 which allows the corresponding note to be emitted from the speaker 15 when the key is pressed. The plurality of natural keys 18 traverse the length of the front surface 11 of the housing 10 of the teaching piano 1. Spaced overtop of the plurality of natural keys 18 are the plurality of accidental keys 20.

The illuminating unit 23 is responsible for causing the natural lights 19 and the accidental lights 21 to be illuminated. The natural lights 19 are illuminated when the corresponding natural key in which the natural light 19 is positioned, is pressed down. The accidental lights 21 are illuminated when the corresponding accidental key in which the natural light 19 is positioned, is pressed down.

Although the invention has been explained in relation to its preferred embodiment, it is to be understood that many other possible modifications and variations can be made without departing from the spirit and scope of the invention as hereinafter claimed.

What is claimed is:

1. A teaching piano comprising:
a housing;
a plurality of natural keys;
a plurality of accidental keys;
a display screen;
a power button;
at least one speaker
a control module;
a power cord;
an illuminating unit; and
a central processing unit.

2. The teaching piano as claimed in claim 1, comprising:
the housing having a front surface;
each of the plurality of natural keys having a natural light; and
each of plurality of accidental keys having an accidental light.

3. The teaching piano as claimed in claim 1, comprising:
the illuminating unit being contained within the housing;
the central processing unit being contained within the housing;
the power cord traversing through a wall of the housing and being electrically connected to the central processing unit;
the display screen being electronically connected to the central processing unit;
each of the natural lights being electronically connected to the illuminating unit; and
each of the accidental lights being electronically connected to the illuminating unit.

4. The teaching piano as claimed in claim 2, comprising:
each of the plurality of natural keys traversing the length of the front surface of the housing;
each of the plurality of accidental keys being spaced overtop the plurality of natural keys;
each of the natural lights being centrally positioned on the lower quadrant of the natural keys; and
each of the accidental lights being centrally positioned on the lower quadrant of the plurality of accidental keys.

5. The teaching piano as claimed in claim 2, comprising:
the front surface of the housing having an upper half and a lower half;
the display screen being mounted on the upper half of the front surface of the housing;
each of the plurality of natural keys and each of the plurality of accidental keys being mounted on the lower half of the front surface of the housing;
the at least one speaker being positioned above the display screen;
the control module being mounted on the front surface of the housing;
the control module being positioned on the left side of the least one speaker; and
the power button being positioned on the right side of the at least one speaker.

6. The teaching piano as claimed in claim 1, comprising:
each of the plurality of accidental keys being electronically connected to the central processing unit;
each of the plurality of the natural keys being electronically connected the central processing unit; and
the control module being electronically connected to the central processing unit.

7. The teaching piano as claimed in claim 1, comprising:
the at least one speaker being electronically connected to the central processing unit;
the illuminating unit being connected electronically to the power cord; and
the power button being electronically connected to the central processing unit.

8. The teaching piano as claimed in claim 1 comprising:
each of the plurality of natural keys being electronically connected to the central processing unit; and
each of the plurality of accidental keys being electronically connected to the central processing unit.

9. A teaching piano comprising:
a housing;
a plurality of natural keys;
a plurality of accidental keys;
a display screen;
a power button;
at least one speaker
a control module;
a power cord;
an illuminating unit;
a central processing unit;
the housing having a front surface;
each of the plurality of natural keys having a natural light;
each of plurality of accidental keys having an accidental light;
each of the plurality of natural keys traversing the length of the front surface of the housing;
each of the plurality of accidental keys being spaced overtop the plurality of natural keys;
each of the natural lights being centrally positioned on the lower quadrant of the natural keys; and
each of the accidental lights being centrally positioned on the lower quadrant of the accidental keys.

10. The teaching piano as claimed in claim 9, comprising:
the illuminating unit being contained within the housing;
the central processing unit being contained within the housing;
the power cord traversing through a wall of the housing and being electrically connected to the central processing unit;
the display screen being electronically connected to the central processing unit;
the natural lights being electronically connected to the illuminating unit;
the accidental lights being electronically connected to the illuminating unit;
the front surface of the housing having an upper half and a lower half;
the display screen being mounted on the upper half of the front surface of the housing;
each of the plurality of natural keys and each of the plurality of accidental keys being mounted on the lower half of the front surface of the housing;
the at least one speaker being positioned above the display screen;
the control module being mounted on the front surface of the housing;
the control module being positioned on the left side of the least one speaker; and
the power button being positioned on the right side of the at least one speaker.

11. The teaching piano as claimed in claim 9, comprising:
the accidental keys being electronically connected to the central processing unit;
the natural keys being electronically connected the central processing unit;
the control module being electronically connected to the central processing unit;
the at least one speaker being electronically connected to the central processing unit; and
the illuminating unit being connected electronically to the power cord.

12. The teaching piano as claimed in claim 9 comprising:
the power button being electronically connected to the central processing unit;
the natural keys being electronically connected to the central processing unit; and
the accidental keys being electronically connected to the central processing unit.

13. A teaching piano comprising:
a housing;
a plurality of natural keys;
a plurality of accidental keys;
a display screen;
a power button;
at least one speaker
a control module;
a power cord;
an illuminating unit;
a central processing unit;
the housing having a front surface;
each of the plurality of natural keys having a natural light;
each of plurality of accidental keys having an accidental light;
each of the plurality of natural keys traversing the length of the front surface of the housing;
each of the plurality of accidental keys being spaced overtop the plurality of natural keys;
each of the natural lights being centrally positioned on the lower quadrant of the natural keys; and
each of the accidental lights being centrally positioned on the lower quadrant of the accidental keys.

14. The teaching piano as claimed in claim 13, comprising:
the illuminating unit being contained within the housing;
the central processing unit being contained within the housing;
the power cord traversing through a wall of the housing and being electrically connected to the central processing unit;
the display screen being electronically connected to the central processing unit;
the natural lights being electronically connected to the illuminating unit;
the accidental lights being electronically connected to the illuminating unit;
the front surface of the housing having an upper half and a lower half;
the display screen being mounted on the upper half of the front surface of the housing;
each of the plurality of natural keys and each of the plurality of accidental keys being mounted on the lower half of the front surface of the housing;
the at least one speaker being positioned above the display screen;
the control module being mounted on the front surface of the housing;
the control module being positioned on the left side of the least one speaker; and
the power button being positioned on the right side of the at least one speaker.

15. The teaching piano as claimed in claim 9, comprising:
the accidental keys being electronically connected to the central processing unit;
the natural keys being electronically connected the central processing unit;
the control module being electronically connected to the central processing unit;
the at least one speaker being electronically connected to the central processing unit;
the illuminating unit being connected electronically to the power cord;
the power button being electronically connected to the central processing unit;
the natural keys being electronically connected to the central processing unit; and
the accidental keys being electronically connected to the central processing unit.
